(19) United States
(12) Patent Application Publication
(10) Pub. No.: US 2008/0160997 A1
(43) Pub. Date: Jul. 3, 2008

(54) International Automatic Roaming Service Method

(76) Inventor: Jin-Hong Kim, Seoul (KR)

Correspondence Address: QUARLES & BRADY LLP, 411 E. WISCONSIN AVENUE, SUITE 2040, MILWAUKEE, WI, 53202-4497, US

(21) Appl. No.: 12/047,902

(22) Filed: Mar. 13, 2008

Related U.S. Application Data
(63) Continuation of application No. 09/737,229, filed on Dec. 14, 2000, now abandoned.

(30) Foreign Application Priority Data
Dec. 15, 1999 (KR) 99-57715

(51) Int. Cl. H04Q 7/20

(52) U.S. Cl. 455/433

(57) ABSTRACT

A method which can allow subscribers to select an international telephone service provider and appropriately provide a wireless communication service to a mobile station subscribed to a foreign wireless communication system is disclosed. The method includes the steps of: a) storing information as to whether the international roaming mobile station subscribes to an international roaming service in a subscriber profile of the mobile station; b) storing MSC IDs in a database of HLR; c) determining whether a REGNOT message is from an MSC of a home system based on the MSC IDs stored in the database when the REGNOT message is inputted from the MSC to the HLR; and d) sending information as to whether the international roaming mobile station subscribes to the international roaming service to the MSC based on the subscriber information when the REGNOT message is not from the home system.

### CROSS-REFERENCE TO RELATED APPLICATION

This application is a continuation of U.S. patent application Ser. No. 09/737,229 filed Dec. 14, 2000, which claims priority to Korean Patent Application No. 99-57715, filed Dec. 15, 1999.

### BACKGROUND OF THE INVENTION

1. Field of the Invention

The present invention relates to a method of providing a wireless communication service to an international roaming mobile station, more particularly to a method which can allow subscribers to select an international telephone service provider and appropriately provide a wireless communication service to a mobile station subscribed to a foreign wireless communication system.

2. Prior Art

The operation of a cellular telephone network for delivering inputted calls to dialed cellular mobile stations is well known in the art. When a mobile station is dialed and a call origination is sent to a home MSC (Mobile Switching Center), in response to the call origination, the home MSC sends a location query message to the HLR (Home Location Resistor). The HLR confirms which MSC serves at the area visited by the dialed mobile station. For preparing call delivery, a routing request message is forwarded from the HLR to the visited MSC. The visited MSC determines the location of the called (or dialed) mobile station and assigns an appropriate routing number (for example, a temporary local directory number) to the called mobile station. And then, the visited MSC responds to the routing request message of the HLR with the routing number. The routing number is forwarded to the home MSC to be used for establishing a communication link between the home MSC and the visited MSC. On the other hand, the delivery of the call to the called mobile station is accomplished by establishing a communication link with a base station controller connected with a base station currently servicing the called mobile station. And then, the radio frequency communication link between the base station and the called mobile station is established.

However, when a calling party number according to a foreign telephone number plan is used as the “Calling Party Number” parameter value of a call setup message, a problem can occur that a communication link for an international roaming mobile station can not be established because of the difference between the foreign and domestic telephone number plans. Furthermore, when a mobile station subscribed to a wireless telephone network of one country is internationally roaming, it is impossible for the subscriber of the mobile station to select a variety of services provided from the subscribed wireless telephone network as desired, as well as to receive an international call service through his desirable international telephone service provider.

### SUMMARY OF THE INVENTION

Therefore, the present invention has been made by taking the above facts into consideration, and an object of the present invention is to provide a method which allows a domestic subscriber to selectively receive an international roaming service.

It is another object of the present invention to provide a method which allows each of the subscribers to select an international telephone service provider when the subscribers receive the international roaming service.

It is a further object of the present invention to provide a method which can provide a wireless communication service to a visiting mobile station international roaming.

In order to achieve the above objects, a method according to one aspect of the present invention includes the steps of: a) storing information as to whether the internationally roaming mobile station subscribes to an international roaming service in a subscriber profile of the mobile station; b) storing mobile switching center identifications (MSC IDs) in a database of a home location register(HLR); c) determining whether a registration notification (REGNOT) message is from an MSC of a home system based on the MSC IDs stored in the database when the REGNOT message is inputted from the MSC to the HLR; and d) sending information as to whether the international roaming mobile station subscribes to the international roaming service to the MSC based on the subscriber information when the REGNOT message is not from the home system.

A method according to another aspect of the present invention includes the steps of: a) registering the international roaming mobile station at an MSC; b) determining whether a routing request message for the international roaming mobile station is for an international call when the routing request message is received at the MSC; and c) generating an international routing number of the international roaming mobile station when the routing request message is for an international call and sending the international routing number.

According to the present invention, a method and an apparatus for repeating a forward link communication signal are provided, which can allow the subscribers to select one international telephone service provider and allow international roaming mobile stations to receive a wireless communication service regardless of the telephone number scheme differences between the countries.

### BRIEF DESCRIPTION OF THE DRAWINGS

This invention will be better understood and its various objects and advantages will be more fully appreciated from the following description taken in conjunction with the accompanying drawings, in which:

FIG. 1 is a view showing one example of international wireless communication network;

FIG. 2 is a signal flow and network operation diagram illustrating the registration of an international roaming mobile station according to the present invention;

FIG. 3 is a signaling flow and network operation diagram illustrating the calling operation of the international roaming mobile station 161 registered in the second country wireless communication network 32 according to the present invention; and

FIG. 4 is a signaling flow and network operation diagram illustrating the process of providing the call service to a mobile station subscribed in the second country wireless communication network according to the present invention when the mobile station visits the first country wireless communication network 12.

### DETAILED DESCRIPTION OF THE PREFERRED EMBODIMENTS

Preferred embodiments of the present invention will be illustrated below with reference to the accompanying drawings.

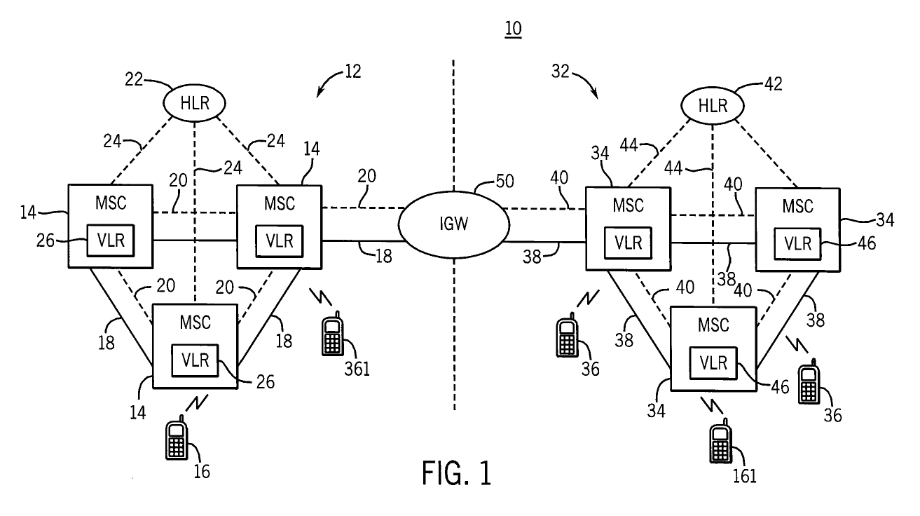

FIG. 1 is a view showing one example of international wireless communication network.

Referring to FIG. 1, an international wireless communication network 10 includes the first country wireless communication network 12 and the second country wireless communication network 32. In FIG. 1, while the wireless communication networks for the two countries are only depicted, it is understood in the art that the international wireless communication network 10 includes the plurality of country wireless communication networks which are interconnected with one another. Also, assuming that the present invention is embodied in the first country wireless communication network 12, the present invention will be described in detail. Therefore, it is understood in the art that the present invention is not limited to a particular wireless communication network.

The first country wireless communication network 12 includes the plurality of interconnected MSCs (mobile switching centers) 14. Though only three MSCs 14 are depicted in the FIG. 1, it can be understood in the art that the first country wireless communication network 12 may include more than three interconnected MSCs.

The MSCs 14 provide digital or analog mobile telephone (for example, cellular, PCS, etc.) service to the plurality of subscriber mobile stations 16. The MSCs 14 are interconnected for communication with one another through both signaling links 20 (illustrated with broken lines) and voice trunks 18 (illustrated with solid lines). The voice trunks 18 provide voice and data communications paths used to carry subscriber communications between the MSCs 14. The signaling links 20 carry command signals between the MSCs 14 used for setting up and releasing voice and data communications links over the voice trunks 18, and for controlling the provision of service features to the subscriber mobile stations 16. The MSCs 14 are connected to an HLR (home location register) 22 by means of the signaling links 24.

The HLR 22 has a database (not shown) which stores information concerning the assigned subscriber mobile stations 16 comprising location information and service information. Further, according to the present invention, the database of the HLR 22 stores information as to whether each of the mobile stations 16 subscribes to an international roaming service and if subscribed, which of the international telephone service providers each of subscribers is served with the international roaming service through, such as international telephone service numbers. The HLR 22 stores ID of each MSC of the second country wireless communication network 32 and MSC IDs of other country wireless communication network (not shown). There are the plurality of virtual origination numbers stored at the HLR 22 for subscribers of the second and any other countries wireless communication networks. When requested from the MSCs 14, the HLR 22 assigns the plurality of virtual origination numbers to the MSCs 14, respectively.

Also, the MSCs 14 are linked to the VLR 26. The VLR 26 dynamically stores subscriber information for subscriber mobile stations currently served by the MSCs 14.

The second country wireless communication network 32 includes the plurality of MSCs 34 interconnected with one another. In FIG. 1, though only three MSCs 34 are depicted, it is understood in the art that the second country wireless communication network 32 may include more than three MSCs 34.

The MSCs 34 conventionally provide the plurality of subscriber mobile stations 36 with a digital or analog wireless communication service. For example, the MSCs 34 operate based on the standard IS-41. The MSCs 34 are interconnected for communication with one another via signaling links 40 and voice trunks 38. As mentioned above, the voice trunks 38 provide voice and data communications paths used to carry subscriber communications between the MSCs 34. The signaling links 40 carry command signals between the MSCs 34 used for setting up and releasing voice and data communications links over the voice trunks 38, and for controlling the provision of service features to the subscriber mobile stations 36. The MSCs 34 are connected to an HLR 42 by means of the signaling links 44.

The HLR 42 has a database (not shown) which stores information concerning the assigned subscriber mobile stations 36 comprising location information and service information.

The HLR 42 operates based on the standard IS-41. Further, the MSCs 34 are linked to the VLR 46. The VLR 46 dynamically stores subscriber information for subscriber mobile stations currently served by the MSCs 34.

An international gateway (IGW) 50 is used to connect at least one of the MSCs 14 of the first country wireless communication network 12 with at least one of the MSCs 34 of the second country wireless communication network 32. It is understood in the art that the IGW 50 can be used to connect a variety of networks for example, PSTN, international telephone service providers, satellite communication networks, etc., with one another.

In FIG. 1, when the mobile station 16 subscribed to the first country wireless communication network 12 visits at the second country wireless communication network 32, the mobile station 16 must register in the MSC 34 of the second country wireless communication network 32 serving the area where the mobile station 16 visits.

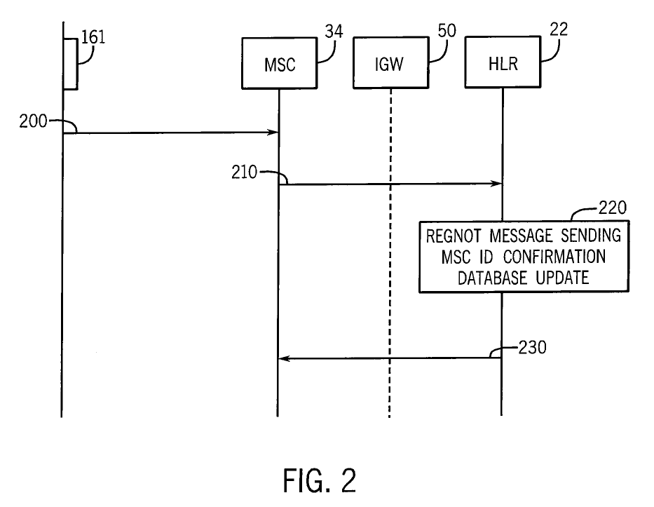

FIG. 2 is a signal flow and network operation diagram illustrating the registration of an international roaming mobile station according to the present invention.

Referring to FIG. 2, when the mobile station subscribed to the first country wireless communication network 12 visits the service area of the MSC 34 of the second country wireless communication network 32, the mobile station 161 sends a registration request message 200 to the MSC 34. When the MSC 34 receives the registration request message 200, the MSC 34 of the second country wireless communication network 32 sends a REGistration NOTification (REGNOT) message 210 through the IGW 50 to the HLR 22 of the first country wireless communication network to which the mobile station 161 is subscribed. When the HLR 22 receives the REGNOT message 210 from the MSC 34, the HLR 22 determines which MSCs 34 generates the REGNOT message 210 based on the MSC ID stored in the database thereof. As the determination result, when the REGNOT message 210 is from a foreign MSC 34, that is, an MSC 34 of the second country wireless communication network 32, the HLR 22 retrieves the profile of the mobile station 161 from the database to determine whether the mobile station 161 is subscribed to the international roaming service (220). And then, when the mobile station 161 is subscribed to the international roaming service, the HLR 22 stores the current location of the mobile station 161 in the database thereof and returns a REGNOT response message together with information (user's profile, interchange carrier ID, shared secret key for authentication, etc.) which the MSC 34 needs for communication service, that is, normal information to the MSC 34. To the contrary, when the mobile station 161 does not subscribe to the international roaming service, the HLR 22 sends a REGNOT response message representing an authority denied parameter to the MSC 34 to prevent the MSC 34 from registering the mobile station 161 (230).

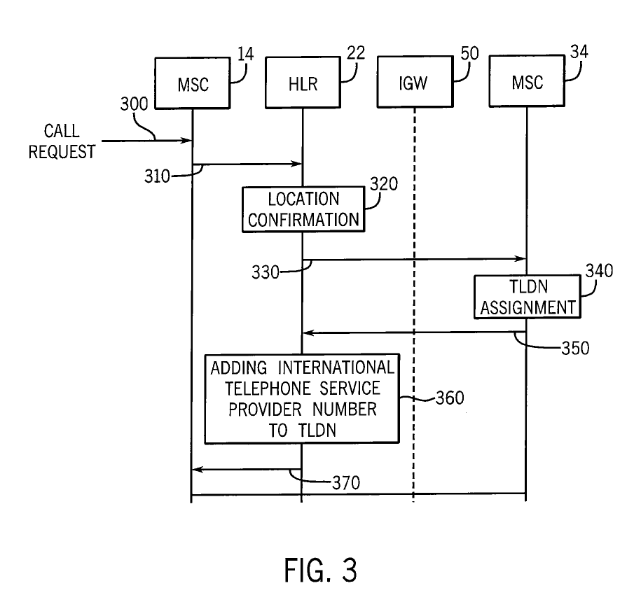

The calling operation of the mobile station 161 registered in a foreign country network will be illustrated below with reference to FIG. 3.

FIG. 3 is a signaling flow and network operation diagram illustrating the calling operation of the international roaming mobile station 161 registered in the second country wireless communication network 32 according to the present invention.

When the MSC 14 of the first country wireless communication network 12 receives a message of calling the international roaming mobile station 161, the MSC 14 of the first country wireless communication network 12 sends a message requesting location information of the mobile station 161 to the HLR 22. When the HLR 22 receives the location information request message from the MSC 14, the HLR 22 confirms the current location of the mobile station 161 based on the database thereof (320). Then, the HLR 22 sends a routing request message 330 through IGW 50 to the MSC 34 currently registered by the mobile station 161. When the routing request message is received, the MSC 34 assigns a routing number (for example, TLDN) in response to the routing request message, and forwards the assigned routing number to the HLR 22 (340, 350). When the routing number is received, the HLR 22 adds the international telephone service provider number, such as “001”, “002”, “00755”, etc., which is stored in the user's profile of the mobile station 161 to the routing number, and sends the added number to the MSC 24 (360, 370). Since the process of establishing the call between the mobile station and a caller is the same as that of IS-41, the detailed description of the process is omitted.

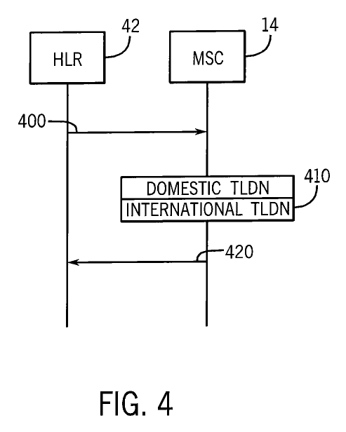

FIG. 4 is a signaling flow and network operation diagram illustrating the process of providing the call service to a mobile station 36 subscribed in the second country wireless communication network 32 according to the present invention when the mobile station 36 visits the first country wireless communication network 12.

When a mobile station 36 subscribed in the second country wireless communication network 32 visits a service area of a MSC 14 of the first country wireless communication network 12, the mobile station 361 registers in MSC 14. The MSC 14 assigns a prepared, predetermined domestic number (for example, TLDN) to the mobile station 361. When the MSC 14 receives a routing request message 400 for the mobile station 361, the MSC 14 determines whether the routing request message originates from MSCs of the first country communication network 12 or any foreign country communication networks for example, the HLR 42 of the second country wireless communication network 32. When the routing request message is from the HLR 42 of the second country wireless communication network 32, the MSC 14 generates an international routing number 410 and forwards the international routing number 410 (for connecting with the second country wireless communication network) to the HLR 42(420). To the contrary, when the routing request message originates from the HLR 22 of the same system, the MSC 14 generates a domestic routing number (used in the first country) 410 and forwards the domestic routing number to the HLR 42(420). Preferably, the international routing number includes the domestic routing number, a country code, and a domestic wireless communication service provider code.

Further, when the visiting mobile station 361 initiates a call, the MSC 14 sends call connect message having the virtual origination number which is assigned to the mobile station 361 in registration instead of the real number of the mobile station 361, such that confusion caused by a different number scheme between two countries is prevented.

According to the present invention, the method allows the subscribers to select one international telephone service provider or more by themselves. Further, according to the present invention, the international roaming mobile stations can receive a wireless communication service regardless of the telephone number scheme differences between the countries.

While this invention has been particularly shown and described with reference to particular embodiments thereof, it will be understood by those skilled in the art that various changes in form and details may be effected therein without departing from the spirit and scope of the invention as defined by the appended claims.

I claim:

1. A method of providing a wireless communication service to a first country roaming mobile station, the method comprising the steps of:
registering the first country roaming mobile station at a MSC in a second country, the second country MSC:
receiving a routing request message for the first country roaming mobile station and determining whether the routing request message is for an international call;
receiving a virtual origination number from a HLR in the second country;
when the routing request message is for an international call, the second country_MSC further:
generating an international routing number for the first country roaming mobile station; and
assigning the virtual origination number to the first country roaming mobile station when a call origination request from the first country roaming mobile station is received.

2. The method of claim 1, wherein the second country MSC further generates a call connect message having the virtual origination number instead of a calling party number.

3. The method of claim 1, wherein the international routing number includes a temporary local directory number, a country code, and a system operator code.
